(19) United States
(12) Patent Application Publication
(10) Pub. No.: US 2021/0399919 A1
(43) Pub. Date: Dec. 23, 2021

(54) ERROR FRAME SHIELDING UNIT FOR A USER STATION OF A SERIAL BUS SYSTEM, AND METHOD FOR COMMUNICATING IN A SERIAL BUS SYSTEM

(71) Applicant: Robert Bosch GmbH, Stuttgart (DE)

(72) Inventors: Arthur Mutter, Neuhausen (DE); Steffen Walker, Reutlingen (DE); Darius Vafi, Braunschweig (DE)

(21) Appl. No.: 17/290,126

(22) PCT Filed: Nov. 11, 2019
(86) PCT No.: PCT/EP2019/080866

§ 371 Date: Apr. 29, 2021

(30) Foreign Application Priority Data
Nov. 12, 2018 (DE) 102018219292.8

(51) Int. Cl. H04L 12/40

(52) U.S. Cl. CPC H04L 12/40026; H04L 2012/40215

(57) ABSTRACT

An error frame shielding unit for a user station of a serial bus system and a method for communicating in a serial bus system are provided. The error frame shielding unit includes a shield decision block for generating a signal that indicates, during a transfer of a message on a bus of the bus system, whether or not a transmission signal, which has been created by the user station due to receiving the message, is to be transmitted onto the bus, and a transmission signal selection block for blocking the transmission signal, which via an error frame on the bus is to indicate a reception error in the message received from the bus as a function of the signal generated by the shield decision block, so that the error frame is not transmitted onto the bus.

The present invention relates to an error frame shielding unit for a user station of a serial bus system, and a method for communicating in a serial bus system, via which a communication in the bus system is selectively possible according to a first communication protocol or a second communication protocol, the communication according to the second communication protocol taking place at a higher bit rate than with the first communication protocol, and with a different physical layer.

### BACKGROUND INFORMATION

For the communication between sensors and control units, for example in vehicles, more and more frequently a bus system is used in which data are transmitted as messages under the ISO 11898-1:2015 standard, as a CAN protocol specification with CAN FD. The messages are transferred between the user stations of the bus system, such as the sensor, control unit, transducer, etc. In the introduction phase, at the present time in the first step CAN FD is generally used in the vehicle with a data bit rate of 2 Mbit/s for the transfer of bits of the data field, and with an arbitration bit rate of 500 kbit/s for the transfer of all other bits, in particular the bits of the arbitration field.

For the transfer of the arbitration field as well as for the transfer of the data field, the same physical layer is used, which corresponds to the bit transfer layer or layer one of the conventional Open Systems Interconnection (OSI) model. A distinction is made between two bus states, namely, “dominant” (which corresponds to the logical or digital 0) and “recessive” (which corresponds to the logical or digital 1). Since the recessive bus state is not actively driven, the recessive bus state may be overwritten by the dominant bus state, thus making the arbitration possible. However, the recessive bus state is set only relatively slowly by terminating resistors of the bus system. On the one hand this prevents a faster data transfer. However, on the other hand the arbitration according to the above-mentioned ISO 11898-1:2015 standard ensures that only one of the user stations transmits its data exclusively and free of collisions during the transfer of the data field. As a result, data are transferable via the bus more securely after the arbitration, without the need for repetition. Overall, this contributes to an acceleration of the data transfer.

Thus, in order to maintain the advantage of the arbitration while still increasing the transfer rate even further than previously, an approach must be found which mitigates the disadvantages of the slow transfer rate during the arbitration according to the above-mentioned ISO 11898-1:2015 standard. For a simple migration of existing bus systems, a further aim is to make it possible for user stations, which still operate according to the existing CAN protocol specifications, to also coexist with user stations in the bus system which already communicate according to a successor CAN protocol specification.

### SUMMARY

An object of the present invention is to provide an error frame shielding unit for a user station of a serial bus system, and a method for communicating in a serial bus system which solve the above-mentioned problems. In particular, the present invention provides an error frame shielding unit for a user station of a serial bus system, and a method for communicating in a serial bus system in which coexistence of user stations that communicate according to the ISO 11898-1:2015 standard or according to a successor CAN protocol specification is also possible.

The object may be achieved by an error frame shielding unit for a user station of a serial bus system in accordance with an example embodiment of the present invention. In an example embodiment of the present invention, the error frame shielding unit includes a shield decision block for generating a signal that indicates, during a transfer of a message on a bus of the bus system, whether or not a transmission signal, which has been created by the user station due to receiving the message, is to be transmitted onto the bus, and a transmission signal selection block for blocking the transmission signal, which via an error frame on the bus is to indicate a reception error in the message received from the bus as a function of the signal generated by the shield decision block, so that the error frame is not transmitted onto the bus.

The error frame shielding unit makes it possible for first user stations of the bus system in a first communication phase to use the same communication format as second user stations, but in a second communication phase to use a different communication format than the second user stations, which does not interfere with the communication of the second user stations. For this purpose, the error frame shielding unit may shield error frames (error flags) of the host user station from the bus in the data phase as the second communication phase. However, it is possible to use error frames (error flags) in the arbitration phase as the first communication phase.

Thus, in a first communication phase an arbitration provided by CAN may be carried out, and in a second communication phase the transfer rate may still be increased considerably compared to CAN FD. A communication of errors may thus be carried out in the arbitration phase via error frames (error flags), even when different physical layers are used in the data phase.

As the result of transmitting the “res bit:=1” that is present in CAN FD, the user station allows a switch to be made over to a new frame format, and subsequently, due to the error frame shielding unit, in the event of an error the communication in the new frame format is not disturbed by error frames (error flags) on the bus.

Due to the coexistence and interoperability of user stations that operate according to the CAN FD communication protocol, and user stations that operate according to a CAN FD successor communication protocol, referred to below as CAN NG, a seamless migration path from CAN FD toward CAN NG is possible. Individual user stations of the bus system, which still are to use only CAN FD, may thus be retrofitted with the error frame shielding unit described above; the CAN NG user stations, which may also transmit and receive CAN FD frames, may be equipped from the outset with the error frame shielding unit. Therefore, no gateways between CAN FD and CAN NG bus systems are necessary.

Advantageous further embodiments of the error frame shielding unit are disclosed herein.

According to one particular embodiment variant of the present invention, the error frame shielding unit described above includes a data phase detection block for detecting the data phase of the message that is serially transferred on the bus, and a transmitter detection block for detecting whether or not the user station at that time is the transmitter of the message, the shield decision block being designed to generate the signal as a response to a detection result of the data phase detection block and a detection result of the transmitter detection block.

According to one option of the present invention, the data phase detection block is designed to detect a state on the bus in order to detect the data phase. According to another option, the data phase detection block is designed to evaluate a digital reception signal, generated from the message that is received from the bus, in order to detect the data phase.

The transmitter detection block may possibly be designed to evaluate a transmission signal that is transmitted from the user station to the bus. The transmitter detection block may be designed to count edge changes of the transmission signal in order to evaluate the transmission signal. Alternatively or additionally, the transmitter detection block may be designed to carry out a sequential decoding of the transmission signal in order to evaluate the transmission signal. Alternatively or additionally, the transmitter detection block may be designed to compare the transmission signal to a digital reception signal, generated from the message that is received from the bus, in order to evaluate the transmission signal.

It is possible for the error frame shielding unit to also include a reception signal decision block for deciding which reception signal the error frame shielding unit passes on to the host user station, the reception signal decision block being designed to make the decision based on a result of whether the user station transmits an error frame, and as a function of the signal that is generated by the shield decision block.

According to one particular variant of the present invention, the error frame shielding unit also includes a transmission signal generation block for generating a transmission signal, in which after a data phase of the message, it is signaled that a reception error has been detected at the user station, the transmission signal generation block being designed to generate the transmission signal and transmit it to the bus if the signal generated by the reception signal decision block indicates that the error frame has been blocked from transmitting onto the bus.

In a first communication phase for transmitting the message onto the bus, it is possibly negotiated, between the user stations of the bus system, which of the user stations in a subsequent second communication phase has, at least temporarily, exclusive, collision-free access to the bus of the bus system, the second communication phase being a data phase in which useful data of the message are transferred on the bus.

The error frame shielding unit described above may be part of a user station for a serial bus system, the user station also including a communication control device for transmitting a message to a bus of the bus system and/or for receiving a message from the bus of the bus system, and a transceiver device for transmitting the message onto the bus, the error frame shielding unit being connected to the communication control device and to the transceiver, and the transceiver device being designed, when transmitting at a first bit rate, to generate a first bus state for a first digital data state of the messages, and to generate a second bus state for the second digital data state of the messages, in such a way that the second bus state may overwrite the first bus state, and the transceiver device, when transmitting at a second bit rate that is higher than the first bit rate, being designed to generate different bus states in such a way that the bus states for the different digital data states of the messages cannot overwrite one another, and the error frame shielding unit being designed to detect when the transceiver device switches over from transmitting at the first bit rate to transmitting at the second bit rate, and from transmitting at the second bit rate to transmitting at the first bit rate.

At least two user stations described above may be part of a bus system that also includes a bus, so that the at least two user stations are connected to one another via the bus in such a way that they may communicate serially with one another. At least one of the at least two user stations is a user station described above.

The bus system described above possibly also includes at least one additional user station, which for transferring the message on the bus is designed only to generate bus states on the bus in a first and second communication phase of the message in such a way that the second bus state may overwrite the first bus state, the at least one additional user station being connected via the bus to the at least two user stations in such a way that the user stations may communicate serially with one another, the at least one additional user station including an error frame shielding unit described above, the error frame shielding unit of the at least one of the above-described user stations and the at least one additional user station being designed to block an error frame if the signal generated by the shield decision block indicates that a message is received at that time in the second communication phase, the format of the message not being understandable by a communication control device of the user station due to an error, and if the communication control device of the at least one additional user station in the meantime attempts to transmit an error frame.

Moreover, the object stated above may be achieved by a method for communicating in a serial bus system according to an example embodiment of the present invention. In accordance with an example embodiment of the present invention, the method includes the steps: transmitting, via a transceiver, messages onto a bus of the bus system and/or receiving, via the transceiver, messages from the bus of the bus system, generating, using a shield decision block unit, a signal that indicates, upon receipt of a message from the bus, whether or not a transmission signal that has been created by the user station due to the receipt of the message is to be transmitted onto the bus, and blocking, using a transmission signal selection block, the transmission signal which is to indicate via an error frame on the bus a reception error in the message that is received from the bus, as a function of the signal that is generated by the shield decision block, so that the error frame is not transmitted onto the bus.

The method yields the same advantages as stated above with regard to the user station.

Further possible implementations of the present invention also include combinations, even if not explicitly stated, of features or specific embodiments described above or discussed below with regard to the exemplary embodiments. Those skilled in the art will also add individual aspects as enhancements or supplements to the particular basic form of the present invention, in view of the disclosure herein.

### BRIEF DESCRIPTION OF THE DRAWINGS

The present invention is described in greater detail below with reference to the figures, and based on exemplary embodiments.

FIG. 1 shows a simplified block diagram of a bus system according to a first exemplary embodiment of the present invention.

FIG. 2 shows a diagram for illustrating the design of messages that may be transmitted from user stations of the bus system according to the first exemplary embodiment of the present invention.

FIG. 3 shows a diagram for illustrating the design of an error frame shielding unit that is installed in user stations of the bus system according to the first exemplary embodiment of the present invention.

FIG. 4 shows a signal-time diagram for various signals that are transmitted according to the first exemplary embodiment of the present invention during operation of the bus system.

Unless stated otherwise, identical or functionally equivalent elements are provided with the same reference numerals in the figures.

### DETAILED DESCRIPTION OF EXAMPLE EMBODIMENTS

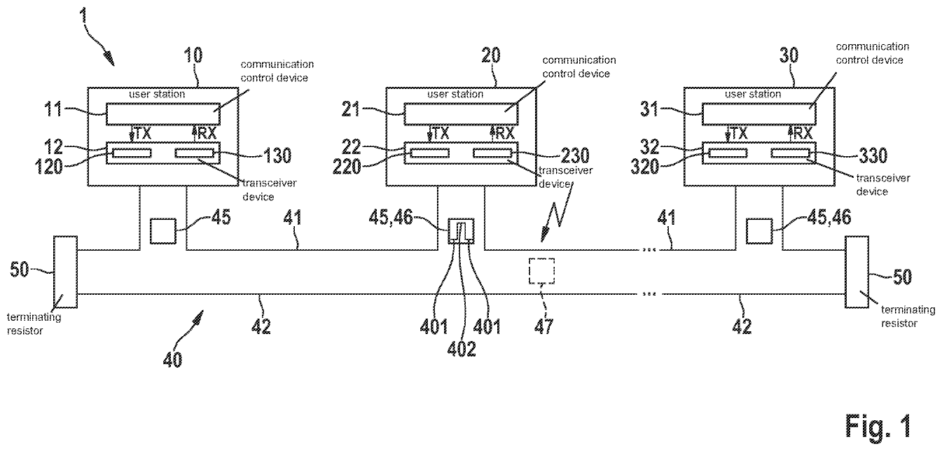

FIG. 1 shows as an example a bus system 1 that is in particular the basis for the design of a CAN bus system, a CAN FD bus system, a CAN FD successor bus system, also referred to as a CAN NG bus system, and/or modifications thereof, as described below. Bus system 1 may be used in a vehicle, in particular a motor vehicle, an aircraft, etc., or in a hospital, and so forth.

In FIG. 1, bus system 1 includes a plurality of user stations 10, 20, 30, each of which is connected to a bus 40 via a first bus wire 41 and a second bus wire 42. Bus 40 at both of its ends is closed off via terminating resistors 50. Bus wires 41, 42 may also be referred to as CAN_H and CAN_L and, using a TX signal in the transmission state, are used for electrical signal transfer after coupling in the dominant levels or states 401, or generating or actively driving recessive levels or states 402. States 401, 402 are shown in a highly schematic manner only for user station 20. States 401, 402 correspond to the states of a TX signal of a transmitting user station 10, 20, 30. After signals CAN_H and CAN_L are transferred on bus wires 41, 42, the signals are received by user stations 10, 20, 30 as an RX signal. Via bus 40, messages 45, 46 in the form of signals CAN_H and CAN_L are serially transferable between individual user stations 10, 20, 30. If an error occurs during the communication on bus 40, as illustrated by the serrated dark block arrow in FIG. 1, an error frame 47 (error flag) may be transmitted. User stations 10, 20, 30 are, for example, control units, sensors, display devices, etc., of a motor vehicle.

As shown in FIG. 1, user station 10 includes a communication control device 11 and a transceiver device 12 that includes a transceiver unit 120 and an error frame shielding unit 130. In contrast, user station 20 includes a communication control device 21 and a transceiver device 22 that includes a transceiver unit 220 and an error frame shielding unit 230. User station 30 includes a communication control device 31 and a transceiver device 32 with a transceiver device 320 and an error frame shielding unit 330. Transceiver devices 12, 22, 32 of user stations 10, 20, 30 are each directly connected to bus 40, although this is not illustrated in FIG. 1.

Communication control devices 11, 21, 31 are each used for controlling a communication of particular user station 10, 20, 30 via bus 40 with another user station of user stations 10, 20, 30 connected to bus 40.

Communication control device 11 may be designed as a conventional CAN controller. Communication control device 11 creates and reads first messages 45, which are CAN FD messages, for example. CAN FD message 45 is built up according to the CAN FD format, in which a number of up to 64 data bytes may be included, which are transferred at a much faster, and thus higher, data rate than for a conventional CAN message. Except for the differences with regard to error frame shielding unit 130 described below, transceiver device 12 may be designed as a conventional CAN FD transceiver.

Each of communication control devices 21, 31 creates and/or reads first messages 45 or second messages 46. Second messages 46 are built up based on a CAN NG format, described in greater detail below. Transceiver devices 22, 32 include a CAN transceiver unit 220, 320, respectively, which as needed may provide one of above-described first messages 45 in the CAN FD format or a second message 46 according to the CAN NG format for associated communication control device 21, 31, or may receive same from the communication control device. In addition, error frame shielding units 230, 330 described in greater detail below are encompassed.

Formation and then transfer of messages 46 having the CAN NG format, and also the reception of such messages 46, are achievable by use of the two user stations 20, 30.

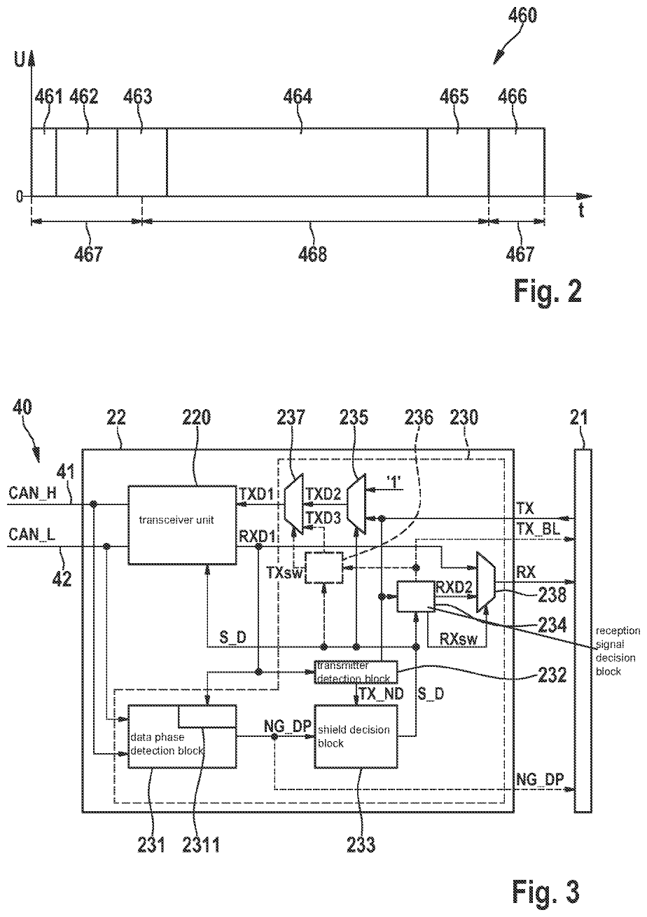

FIG. 2 shows for message 46 a CAN NG frame 460, which is transmitted from transceiver device 22 or transceiver device 32 onto bus 40 as a difference signal due to a TX signal or is received from the bus, from which the RX signal is generated.

CAN NG frame 460 is divided into different fields for the CAN communication on bus 40, namely, a start field 461, an arbitration field 462, a control field 463, a data field 464, a check sum field 465, and an end field 466. Except for the differences of control field 463 described below, a frame for first message 45 is built up in the same way as frame 460. A data phase 468 begins after a certain bit of control field 463, with which a switchover is made from the arbitration phase to data phase 468. Data phase 468 thus includes a portion of control field 463 as well as data field 464 and check sum field 465. All other fields of frame 460 are part of arbitration phase 467.

Start field 461 includes one bit, for example, also referred to as an SOF bit, and indicates the start of frame. Arbitration field 462 contains an identifier including 32 bits, for example, for identifying the sender of the message. Arbitration field 462 may additionally contain a piece of protocol format information made up of one or multiple bits, which is suitable for distinguishing CAN NG frames from CAN frames or CAN FD frames. However, the following description assumes that the CAN NG frame (second message 46) is identical to the frame format for CAN FD (first message 45) except for the FDF bit.

Control field 463 includes a piece of protocol format information, mentioned above, which is made up of one or multiple bits and which is suitable for distinguishing CAN NG frames from conventional CAN frames or CAN FD frames. Control field 463 contains a data length code that is 12 bits long, for example, which may assume values from 1 to 4096 with an increment of 1, or alternatively, values from 0 to 4095. The data length code may alternatively include fewer or more bits, and the value range and the increment may assume other values.

Data field 464 contains the useful data of the CAN NG frame or of message 46. The useful data may include up to 64 bytes or 4096 bytes, for example, or some other arbitrary number of bytes, corresponding to the value range of the data length code.

Check sum field 465 contains a check sum concerning the data in data field 464, including the stuff bits, which are inserted by the sender of message 46 as inverse bits after every 5 or 10 identical bits, for example.

End field 466 may contain at least one acknowledge bit, one negative acknowledge bit, and also a sequence of 11 identical bits that indicate end E of CAN NG frame 460. The at least one acknowledge bit may be used to communicate to the transmitting user station that a receiver has correctly received CAN NG frame 460 or message 46; the negative acknowledge bit may be used to communicate to the transmitting user station whether or not a receiver has discovered an error, which may also be referred to as a reception error, in received CAN NG frame 460 or message 46.

A physical layer, similarly as with conventional CAN and CAN FD, is used in arbitration phase 467. An important point during this phase is that the conventional CSMA/CR method is used, which allows simultaneous access of user stations 10, 20, 30 to bus 40 without destroying higher-priority message 45, 46. It is thus possible to add further bus user stations 10, 20, 30 to bus system 1 in a relatively simple manner, and the communication bandwidth is utilized very efficiently, which is very advantageous.

Consequently, the CSMA/CR method must provide so-called recessive states 402 on bus 40, which may be overwritten by other user stations 10, 20, 30 with dominant states 401 on bus 40. In recessive state 402, high-impedance conditions prevail at individual user station 10, 20, 30, which in combination with the parasites of the bus wiring result in longer time constants.

This results in a limitation of the maximum bit rate of the present-day CAN FD physical layer to approximately 2 megabits per second at the present time during actual vehicle use.

Control field 463 and data field 464 are transmitted by a sender of message 5 onto bus 40 only after user station 20 or user station 30, as the sender, has won the arbitration, and user station 20, as the sender for transmitting fields 463 through 466, thus has exclusive access to bus 40 of bus system 1. During the arbitration, with the aid of the identifier in arbitration field 462, bit-by-bit negotiation is carried out between user stations 10, 20, 30 concerning which user station 10, 20, 30 is allowed to transmit message 45, 46 having the highest priority, and therefore for the next time period for transmitting fields 463 through 465, obtains exclusive access to bus 40 of bus system 1.

The arbitration at the start of a frame 460 or of message 45, 46, and the acknowledgment in end field 466 at end E of frame 460 or of message 45, 46, is possible only when the bit time is much more than twice as long as the signal propagation time between two arbitrary user stations 10, 20, 30 of bus system 1.

Therefore, the bit rate in arbitration phase 467 during transfer of fields 461, 462, 463 in part, and 466 is selected to be slower, and thus lower, than in the other fields of frame 460. In particular, in practice the bit rate in the arbitration phase is selected as 500 kbit/s, resulting in a bit time of approximately 2 μs, whereas the bit rate in data phase 468 is selected, for example, as 5 to 8 Mbit/s or greater, resulting in a bit time of approximately 0.2 μs and less. The bit time of the signal in arbitration phase 467 is thus greater than the bit time of the signal in data phase 468 by, for example, a factor of 4 or 10, etc. The factor for the bit time is arbitrarily selectable.

Each of user stations 10, 20, 30 may transmit and receive CAN FD frames, but user station 10 cannot transmit or receive CAN NG frames 460. For example, if user station 20 transmits a CAN NG frame 460 that CAN FD user station 10 cannot understand, error frame shielding unit 230 becomes active for CAN FD user station 10 so that the communication in bus system 1 is not destroyed. This also encompasses, for a local bit error in the res bit, that error frame shielding unit 230 may shield error frame 47 which has been sent because one of user stations 10, 20, 30 (NG, FD) erroneously assumes that this is a CAN FD frame (message 45), and therefore after a pair of bits establishes an error, for example a stuffing error, in the received frame incorrectly regarded as CAN FD frame 450. Accordingly, the method carried out by user station 10, 20, 30 also allows in the bus system at least one CAN FD user station that transmits messages according to the CAN FD protocol and understands CAN NG frame 460.

In the new, alternative frame format, namely, frame 460 of CAN NG message 46, a switchover is made from the CAN FD frame format to the CAN NG frame format with the aid of res bits in control field 463. The frame formats of CAN FD and CAN NG are the same except for the res bit. Thus, user stations 20, 30 each also support CAN FD. A switch may subsequently be made over to a different physical layer that allows a higher bit rate than in preceding arbitration phase 467. Thus, by use of a first physical layer, first bus state 401 for a first digital data state of messages 46 is generated and a second bus state 402 for the second digital data state of messages 46 is generated in such a way that first bus state 401 may overwrite second bus state 402, i.e., the dominant bus state may overwrite the recessive bus state. According to one variant, the second physical layer may be used to generate different bus states 401, 402 in such a way that bus states 401, 402 are not able to overwrite one another for the different digital data states of messages 46. Thus, there are no dominant or recessive bus states for the second physical layer.

In the CAN FD protocol, the res bit is already reserved for new formats. In this regard, res=0 identifies the CAN FD frame format. In contrast, res=1 identifies new, alternative frame format 460 that is used by CAN NG. If a user station 10 recognizes a res=1, it goes into the protocol exception state, which corresponds to a passive waiting state. A departure is not made from this waiting state until such a user station 10 detects 11 recessive bits in succession.

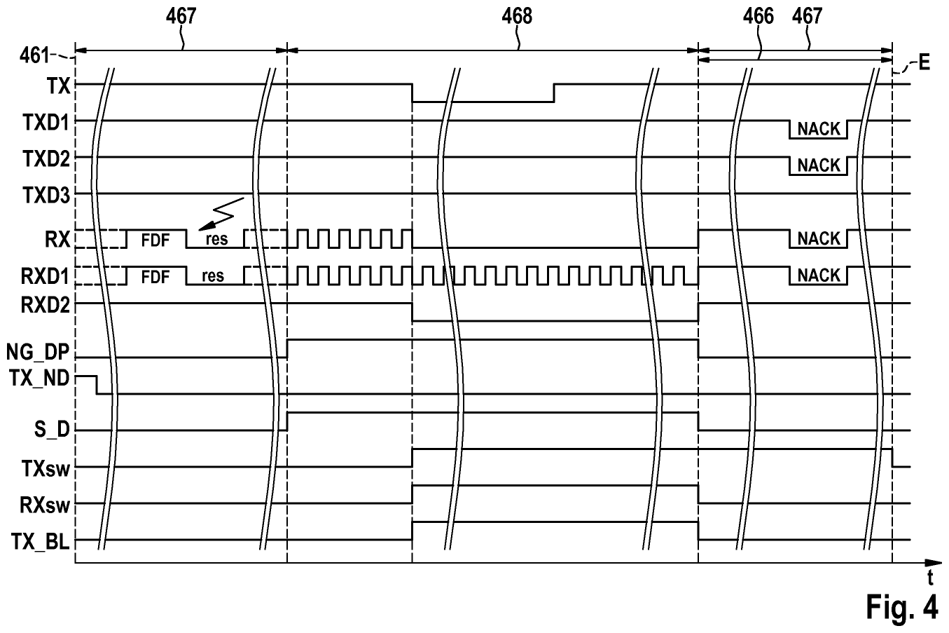

In the event of an error of transmission signal TX or TX signal in the res bit, user station 20, 30 transmitting the TX signal or the TX user station transmits an error frame 47 (error flag), as shown in FIG. 1, and does not switch over to the alternative format according to frame 460. The treatment of a possible error response due to an error of reception signal RX or the RX signal in a receiving user station 10, 20, 30 or RX user station takes place using error frame shielding units 130, 230, 330. This is described below with reference to FIGS. 3 and 4.

Error frame shielding units 130, 230, 330 thus make it possible for user stations 10, 20, 30 to coexist in bus system 1, since a user station 10, 20, 30 that has not detected the switchover to the format of CAN NG frame 460 cannot interfere with data phase 468 of a transmitted CAN NG frame 460. In particular, during the data phase of the CAN NG frame, an error frame 47 cannot trigger a “short circuit” when the transceiver device of the sender of CAN NG frame 460, which is part of the TX node or the TX user station, and the transceiver device which transmits error frame 47 and is part of the RX node or an RX user station, drive against one another.

In general, in bus system 1 with CAN NG, the following properties which differ in comparison from CAN FD may be implemented:
a) acquiring and optionally adapting proven properties that are responsible for the robustness and user-friendliness of CAN FD, in particular a frame structure including identifiers and arbitration according to the CSMA/CR method,
b) a substantial increase in the net data transfer rate,
c) in data phase 468, CAN NG uses a different physical layer than does CAN FD, for example a physical layer in which both bus states are actively driven, and error frames (error flags) are not provided during data phase 468. With such a physical layer for CAN NG, much higher bit rates may be achieved than with CAN FD.

FIG. 3 shows an example of the design of error frame shielding unit 230 in transceiver device 22. Error frame shielding units 130, 330 have the same design, so that the following description also applies to error frame shielding units 130, 330.

Transceiver device 22 includes transceiver unit 220, which is designed to provide the appropriate physical layers for the various phases of CAN FD messages 45 and of CAN NG messages 46 for bus 40. In addition, transceiver unit 220 is designed to receive CAN FD messages 45 and to receive CAN NG messages 46 from bus 40. Transceiver unit 220 may in each case switch over between transmitting and/or receiving CAN FD messages 45 and transmitting and/or receiving CAN NG messages 46. Transceiver unit 220 is connected to bus wires 41, 42 in order to receive signals CAN_H and CAN_L, and is connected to error frame shielding unit 230.

At error frame shielding unit 230, the digital TX signal, also referred to as transmission signal TXD, is received from communication control device 21 and output as a digital TXD1 signal to transceiver unit 220. Taking into account an input signal S_D, transceiver unit 220 encodes the TXD1 signal on the particular physical layer used for the different communication phases, namely, arbitration phase 467 or data phase 468, of messages 45, 46. At the same time, transceiver unit 220 decodes the state on bus 40, i.e., signals CAN_H, CAN_L on bus wires 41, 42, and passes on the result as a digital RXD1 signal to error frame shielding unit 230. As described above, error frame shielding unit 230 generates the digital RX signal, also referred to as reception signal RXD, from the RXD1 signal.

Alternatively or additionally, it is possible for transceiver unit 220 to encode the TXD1 signal on the particular physical layer used for different communication phases 467, 468, taking into account a TX_Enable signal from communication control device 21.

If CAN NG physical layer is such that both bus states 401, 402 are driven in data phase 468 of CAN NG frame 460, transceiver unit 220 deduces that while signal S_D is set (S_D=“1”), bus 40 is not allowed to be driven and must be high-impedance, for example.

Error frame shielding unit 230 includes a data phase detection block 231, a transmitter detection block 232, a shield decision block 233, a reception signal decision block 234, a first transmission signal selection block 235, a transmission signal generation block 236, a second transmission signal selection block 237, and a reception signal selection block 238. Since transmission signal generation block 236 is optional, it and the lines attaching it in error frame shielding unit 230 are illustrated by dashed lines.

Data phase detection block 231 records or detects data phase 468 of CAN NG frame 460. Data phase detection block 231 signals with the aid of digital signal NG_DP whether a frame transfer is present in data phase 468 of a CAN NG frame 460. For example, NG_DP:=1 applies when a transfer of a CAN NG frame is present in data phase 468 at that time; otherwise, NG_DP:=0.

For this purpose, data phase detection block 231 uses signals CAN_H and CAN_L in order to decide whether data phase 468 is taking place at that time. Since CAN NG uses a different physical layer for data phase 468 than for arbitration phase 467, in data phase 468 of a CAN NG frame 460, different differential voltages occur between CAN_H and CAN_L than in data phase 468 of a CAN FD message 45. Data phase detection block 231 thus recognizes, based on the physical layer used, whether the transmission of a CAN NG frame 460 is present in data phase 468.

In addition, data phase detection block 231 uses signal RXD1. Data phase detection block 231 includes a very simplified CAN NG communication control device 2311 for this purpose. CAN NG communication control device 2311 observes signal RXD1 from transceiver unit 220, and may thus predict exactly when data phase 468 begins and when data phase 468 ends. The end of data phase 468 depends on the number of transferred bytes. The number of useful data bytes in data field 464 is encoded in the data length field at the start of data phase 468. Data phase detection block 231 may thus determine the end of data phase 468 by counting bits.

By combining the two detection results from signal RXD1 and bus signals CAN_H, CAN_L, it is possible for data phase detection block 231 to always make a majority decision or AND decision; i.e., data phase detection block 231 sets signal NG_DB=1 only when both detection results show that data phase 468 is present at that time.

However, the most conservative and thus the most reliable is the alternative option that as soon as one of the detection results from signal RXD1 and bus signals CAN_H, CAN_L indicates that data phase 468 is present, data phase detection block 231 assumes this to be true.

As a variant for detecting data phase 468, the combination of the two detection results from signal RXD1 and bus signals CAN_H, CAN_L is very robust against disturbances at bus 40. Such a disturbance could be that a bit error in the RXD1 data stream due to irradiation leads communication control device 2311 in data phase detection block 231 to believe that frame 460 is shorter than in reality, or that a CAN FD message 45 is transferred.

Optionally, signal NG_DP is relayed to communication control device 21, as illustrated by a dashed line in FIG. 3. With the aid of signal NG_DP, for example communication control device 21 or the software of user station 20 may understand, for example, why bus 40 is blocked for so long, namely, because a CAN NG frame 460 occupies bus 40 at that time.

Transmitter detection block 232 records or detects whether or not user station 20 at that time is the sender of message 45, 46. As the result, transmitter detection block 232 signals with the aid of a signal TX_ND whether or not user station 20 is transmitting at that time. For example, TX_ND:=1 applies when user station 20 is transmitting at that time. Otherwise, TX_ND:=0 applies.

Transmitter detection block 232 observes signal TX provided by communication control device 21, and for example counts the number of edge changes of signal TX in a predetermined time period T. If more than 0 edge changes occur in predetermined time period T, transmitter detection block 232 decides that user station 20, i.e., the host user station, is transmitting at that time. To check the plausibility of this information, sender detection block 232 may optionally count the number of edge changes at signal RXD1 in predetermined time period T. If the number of edge changes in signals TX, RXD1 is similar and has at least a value>0, transmission detection block 232 decides that user station 20 is transmitting at that time.

Alternatively, transmitter detection block 232 may be designed as a counter for carrying out the recording or detection. In particular, a counter may be used which is incremented by one edge at transmission signal TX and decremented by one edge at reception signal RX. If the value of the counter is negative, transmitter detection block 232 decides that user station 20 is not transmitting at that time. Otherwise, transmission detection block 232 decides that user station 20 is transmitting at that time. Transmitter detection block 232 resets the counter between two messages 45, 46.

Shield decision block 233 decides whether or not the TX signal of user station 20, i.e., the host user station, is to be blocked, i.e., not transmitted onto bus 40. Shield decision block 233 generates a signal S_D which signals whether blocking or shielding of an error frame 47 is to take place in a case in which the host user station transmits an error frame 47. For this purpose, shield decision block 233 processes input signals TX_ND and NG_DP. For example, S_D:=“1” means that an error frame 47 is to be blocked. Otherwise, an error frame 47 is not to be blocked. If signal NG_DP is set, i.e., data phase 468 of a CAN NG frame 460 is present at that time, and if signal TX_ND is not set, i.e., the host user station is not the sender at that time, shield decision block 233 sets signal S_D so that transmission signal TX is blocked.

If signal S_D is set, i.e., transmission signal TX is to be blocked, first transmission signal selection block 235 is switched in such a way that transmission signal TX is not passed on. Instead of transmission signal TX, a neutral “1” that is input into selection block 235 is passed on. First transmission signal selection block 235 may be designed as a multiplexer. In order for user station 20 to leave bus 40 alone during the transmission of data phase 468 of a CAN NG frame 46 when this user station is only the receiver of message 46 from bus 40, i.e., does not act as the sender of message 46, signal S_D is also passed on to transceiver unit 220.

Reception signal decision block 234 decides which reception signal RX user station 20, i.e., the host user station, obtains via signal RXD1. If signal S_D is set, i.e., data phase 468 of a CAN NG frame 460 is transmitted, and if signal TX_ND is not set, i.e., the host user station is not the sender at that time, and signal TX meanwhile assumes the value “0,” i.e., an error frame 47 is transmitted, reception signal selection block 238 is switched over with the aid of a signal RXsw so that signal RXD2 is passed through from reception signal decision block 234 to user station 20, i.e., the host user station.

If signal S_D=“1” applies and transmission signal TX has assumed the value “0,” signal RXD2 is set to “0” and signal RXsw is set so that reception signal selection block 238 forwards signal RXD2 as signal RX to communication control device 21.

If transmission signal TX once again assumes the value “1,” this has no effect on signals RXsw and RXD2. Only when signal S_D assumes the value “0,” i.e., is not set, is signal RXD2 reset to “1” and signal RXsw reset, so that reception signal selection block 238 once again switches through signal RXD1 as signal RX.

Optionally, reception signal decision block 234 may additionally signal to host CAN NG communication control device 21 that its error frame 47 has been blocked. This may take place via an additional signal, for example via a signal TX_BL that is 1 bit wide. Alternatively, the signaling that error frame 47 has been blocked may be communicated via a Serial Peripheral Interface (SPI). Signal TX_BL may be ascertained from signal RXD2 as follows, for example: TX_BL:=not (RXD2). In the event of negative feedback, i.e., that an error frame 47 has been blocked, user station 20 is informed that user station 20, more precisely, communication control device 21, has transmitted something during data phase 468 of a CAN NG frame 460.

In all other cases, signal RXD1 is passed through from transceiver unit 220, via reception signal selection block 238, to communication control device 21 of user station 20. These other cases are, on the one hand, when signal S_D=“0,” i.e., is not set, and signal TX has an arbitrary value, and on the other hand, when signal S_D=“1,” i.e., is set, and signal TX=“1”.

Transmission signal generation block 236 and transmission signal selection block 237 are optionally present. Transmission signal selection block 237 may be designed as a multiplexer.

Transmission signal generation block 236 is designed to signal on bus 40 as to whether user station 20 has had a reception error. Transmission signal generation block 236 decides whether or not a reception error is present, using signals S_D and TX_BL as input signals. If signal TX_BL is set while signal S_D is also set, transmission signal generation block 236 decides that a corresponding piece of information concerning the reception error is to be transmitted onto bus 40. Transmission signal generation block 236 stores this information in particular in a register.

For signaling the information in question concerning the reception error, transmission signal generation block 236 generates a signal TXD2 which may be forwarded to transceiver unit 220. Thus, signal TXD2 may signal a faulty reception in end field 466 of CAN NG frame 460. For the case that the CAN NG frame format uses positive and negative acknowledgments in end field 466 after transmitting data phase 468 of CAN NG frame 460, transmission signal generation block 236 will transmit a negative acknowledgement. The position of the negative acknowledge bit may, for example, be hard-coded in transmission signal generation block 236 as a number that corresponds to the number of bits, beginning at the end of data phase 468.

If signal S_D changes to “not set,” transmission signal generation block 236 deduces that data phase 468 of CAN NG frame 460 has ended.

Alternatively, transmission signal generation block 236 may transmit an error frame 47, for example, after data phase 468.

In order to transmit something, transmission signal generation block 236 switches second transmission signal selection block 237 in such a way that signal TXD2 of the latter is switched through to transceiver unit 220.

Transmission signal generation block 236 retains control of the TX signal, with the aid of signal TXD2, until CAN NG frame 460 has ended.

Transmission signal generation block 236 subsequently goes into an initial state once again in which transmission signal generation block 236 switches second transmission signal selection block 237 in such a way that signal TXD3 is passed through to transceiver unit 220.

FIG. 4 shows an example of the above-mentioned signals as a function of time t for the case that user station 20 is only the receiver of a message 45, 46, i.e., is an RX user station, and is mistakenly waiting for a CAN FD message 45 due to the error illustrated by the serrated dark block arrow, although a CAN NG message 46 is transmitted. An arbitrary value of a signal is illustrated by dashed lines. The propagation times of the signals are assumed to be 0 in FIG. 4 for easier understanding of the signal-time diagram of FIG. 4.

In FIG. 4, it is apparent at signal TXD1 that error frame 47, which is to be transmitted with the aid of transmission signal TX, has been blocked. In addition, it is apparent at signal TXD1 that a negative acknowledgment (NACK) has been sent in order to signal to the other CAN NG user station(s) 20, 30 that user station 20 has not received message 46. However, the other CAN NG user station(s) 20, 30 may only recognize that one of user stations 10, 20, 30 of bus system 1 has not received message 46.

According to a second exemplary embodiment, data phase detection block 231 carries out its detection only using bus signals CAN_H, CAN_L. Otherwise, the function of error frame shielding unit 230 is designed as in the preceding exemplary embodiment.

The variant of data phase detection block 231 according to the present exemplary embodiment is thus less complicated than the variant of data phase detection block 231 according to the preceding exemplary embodiment. However, in the present exemplary embodiment, a disturbance that is recognizable only via the detection and evaluation of signal TXD1 cannot be identified.

According to a third exemplary embodiment, data phase detection block 231 carries out its detection only using signal TXD1. Otherwise, the function of error frame shielding unit 230 is designed as in the first exemplary embodiment.

The variant of data phase detection block 231 according to the present exemplary embodiment is thus less complicated than the variant of data phase detection block 231 according to the first exemplary embodiment. However, in the present exemplary embodiment, a disturbance that is recognizable only via the detection and evaluation of bus signals CAN_H, CAN_L cannot be identified.

According to a fourth exemplary embodiment, transmitter detection block 232 is designed as a simplified CAN NG communication control device that uses signal TX as an input signal. Due to the sequential decoding of transmitted CAN NG frame 460, the simplified CAN NG communication control device may very easily and reliably decide whether or not user station 20, i.e., the host user station, is a sender. If signal TX remains at the value 1, for example beginning with a certain bit during arbitration phase 467, the simplified CAN NG communication control device deduces that user station 20, i.e., the host user station, has lost the arbitration, i.e., is not the sender.

This embodiment of transmission detection block 232 for detecting whether user station 20 is the sender is more robust or more reliable than the embodiment of transmitter detection block 232 according to the first exemplary embodiment. However, the present embodiment of transmitter detection block 232 has higher resource requirements than the embodiment of transmitter detection block 232 according to the first exemplary embodiment.

According to a fifth exemplary embodiment, reception signal selection block 238 and transmission signal generation block 236 are present. If in this case reception signal selection block 238 has actually blocked an error frame 47, i.e., signal TX_BL has been set, reception signal selection block 238 may set signal RX to the value “0,” and may predefine, with the aid of signal RXD2:=“0” and signal RXsw, until the start of the 11 recessive bits at the end of end field 466, i.e., during the acknowledgment and negative acknowledge bits, that signal RX has the value “0.” This differs from the first exemplary embodiment, in which reception signal selection block 238 predefines previously indicated signal RX only to the end of data phase 468.

Reception signal selection block 238 may recognize the start of the 11 recessive bits at the end of end field 466, for example, by counting bits beginning at the change of signal S_D from 1 to 0.

All of the above-described embodiments of communication control devices 21, 31, of transceiver devices 22, 32, of error frame shielding units 130, 230, 330, of user stations 10, 20, 30 of bus system 1, and of the method carried out therein may be used alone or in any possible combination. In particular, all features of the above-described exemplary embodiments and/or modifications thereof may be arbitrarily combined. Additionally or alternatively, in particular the following modifications are possible.

Above-described bus system 1 according to the exemplary embodiments is described with reference to a bus system based on the CAN protocol. However, bus system 1 according to the exemplary embodiments may also be some other type of communications network in which data are serially transferable at two different bit rates. It is advantageous, but not a mandatory requirement, that in bus system 1, exclusive, collision-free access of a user station 10, 20, 30 to a shared channel is ensured, at least for certain time periods.

The number and arrangement of user stations 10, 20, 30 in bus system 1 of the exemplary embodiments is arbitrary. In particular, user station 10 in bus system 1 may be dispensed with. In this case, error frame shielding units 230, 330 are necessary when user stations 20, 30 are also able to transmit in the CAN FD format, so that the transfer of data phase 468 of CAN NG frame 460 is not disturbed when one of user stations 20, 30 has not successfully switched over to the format of data phase 468 of CAN NG frame 460. It is possible for one or more of user stations 20 or 30 to be present in bus system 1.

At least one of error frame shielding units 130, 230, 330 is possibly situated externally from transceiver device 22, 32. In particular, at least one of error frame shielding units 130, 230, 330 is provided as a separate unit of user station 10, 20, 30.

1-12. (canceled)

13. An error frame shielding unit for a user station of a serial bus system, comprising:
a shield decision block configured to generate a signal that indicates, during a transfer of a message on a bus of the bus system, whether or not a transmission signal, which has been created by the user station due to receiving the message, is to be transmitted onto the bus; and
a transmission signal selection block configured to block the transmission signal, which, via an error frame on the bus, is to indicate a reception error in the message received from the bus, as a function of the signal generated by the shield decision block, so that the error frame is not transmitted onto the bus.

14. The error frame shielding unit as recited in claim 13, further comprising:
a data phase detection block configured to detect a data phase of the message that is serially transferred on the bus; and
a transmitter detection block configured to detect whether or not the user station is the sender of the message;
wherein the shield decision block is configured to generate the signal as a response to a detection result of the data phase detection block and a detection result of the transmitter detection block.

15. The error frame shielding unit as recited in claim 14, wherein the data phase detection block is configured to detect a state on the bus in order to detect the data phase, and/or the data phase detection block is configured to evaluate a digital reception signal, generated from the message that is received from the bus, to detect the data phase.

16. The error frame shielding unit as recited in claim 14, wherein the transmitter detection block is configured to evaluate a first transmission signal that is transmitted from the user station to the bus.

17. The error frame shielding unit as recited in claim 15, wherein the transmitter detection block is configured to count edge changes of the transmission signal in order to evaluate the transmission signal, and/or the transmitter detection block is configured to carry out a sequential decoding of the transmission signal in order to evaluate the transmission signal, and/or the transmitter detection block is configured to compare the transmission signal to a digital reception signal, generated from the message that is received from the bus, in order to evaluate the transmission signal.

18. The error frame shielding unit as recited in claim 13, further comprising:
a reception signal decision block configured to decide which reception signal the error frame shielding unit passes on to the user station, the reception signal decision block being designed to make the decision based on a result of whether the user station transmits an error frame, and as a function of the signal that is generated by the shield decision block.

19. The error frame shielding unit as recited in claim 13, further comprising:
a transmission signal generation block configured to generating a first transmission signal, in which after a data phase of the message, it is signaled that a reception error has been detected at the user station, the transmission signal generation block being configured to generate the first transmission signal and transmit the first transmission signal to the bus if the signal generated by the reception signal decision block indicates that the error frame has been blocked from transmitting onto the bus.

20. The error frame shielding unit as recited in claim 13, wherein, in a first communication phase for transferring the message onto the bus, it is negotiated, between the user stations of the bus system, which of a plurality of user stations in a subsequent second communication phase has, at least temporarily, exclusive, collision-free access to the bus of the bus system, the second communication phase being a data phase in which useful data of the message are transferred on the bus.

21. A user station for a serial bus system, comprising:
a communication control device configured to transmit a message to a bus of the bus system and/or receive a message from the bus of the bus system;
a transceiver device configured to transmit a message onto the bus;
an error frame shielding unit connected to the communication control device and to the transceiver device, the error frame shielding unit including:
a shield decision block configured to generate a signal that indicates, during a transfer of the message on the bus of the bus system, whether or not a transmission signal, which has been created by the user station due to receiving the message, is to be transmitted onto the bus, and
a transmission signal selection block configured to block the transmission signal, which via an error frame on the bus is to indicate a reception error in the message received from the bus, as a function of the signal generated by the shield decision block, so that the error frame is not transmitted onto the bus;
wherein the transceiver device is configured to, when transmitting at a first bit rate, generate a first bus state for a first digital data state of messages, and to generate a second bus state for the second digital data state of the messages, in such a way that the second bus state may overwrite the first bus state, and the transceiver device is configured to, when transmitting at a second bit rate that is higher than the first bit rate, generate different bus states in such a way that the bus states for the different digital data states of the messages cannot overwrite one another, and wherein the error frame shielding unit is configured to detect when the transceiver device switches over from transmitting at the first bit rate to transmitting at the second bit rate, and from transmitting at the second bit rate to transmitting at the first bit rate.

22. A bus system, comprising:
a bus; and
at least two user stations that are connected to one another via the bus in such a way that they may communicate serially with one another, and of which at least one user station includes:
a communication control device configured to transmit a message to the bus and/or receive a message from the bus of the bus system;
a transceiver device configured to transmit the message onto the bus;
an error frame shielding unit connected to the communication control device and to the transceiver device, the error frame shielding unit including:
a shield decision block configured to generate a signal that indicates, during a transfer of the message on the bus of the bus system, whether or not a transmission signal, which has been created by the user station due to receiving the message, is to be transmitted onto the bus, and
a transmission signal selection block configured to block the transmission signal, which via an error frame on the bus is to indicate a reception error in the message received from the bus, as a function of the signal generated by the shield decision block, so that the error frame is not transmitted onto the bus;
wherein the transceiver device is configured to, when transmitting at a first bit rate, generate a first bus state for a first digital data state of messages, and to generate a second bus state for the second digital data state of the messages, in such a way that the second bus state may overwrite the first bus state, and the transceiver device is configured to, when transmitting at a second bit rate that is higher than the first bit rate, generate different bus states in such a way that the bus states for the different digital data states of the messages cannot overwrite one another, and wherein the error frame shielding unit is configured to detect when the transceiver device switches over from transmitting at the first bit rate to transmitting at the second bit rate, and from transmitting at the second bit rate to transmitting at the first bit rate.

23. The bus system as recited in claim 22, further comprising:
at least one additional user station, which for transferring the message on the bus, is configured to generate bus states on the bus only in a first and second communication phase of the message in such a way that the second bus state may overwrite the first bus state, the at least one additional user station being connected via the bus to the at least two user stations in such a way that the at least two user stations and the at least one additional user station may communicate serially with one another, the at least one additional user station including a second error frame shielding unit, the second error frame shielding unit of the at least one additional user station including:
a second shield decision block configured to generate a second signal that indicates, during a transfer of a second message on the bus, whether or not a second transmission signal, which has been created by the at least one additional user station due to receiving the second message, is to be transmitted onto the bus, and
a second transmission signal selection block configured to block the second transmission signal, which via a second error frame on the bus is to indicate a reception error in the second message received from the bus, as a function of the second signal generated by the second shield decision block, so that the second error frame is not transmitted onto the bus;
wherein the second error frame shielding unit and the at least one additional user station are configured to block the second error frame if the second signal generated by the second shield decision block indicates that the second message is received at that time in the second communication phase, a format of the second message not being understandable by a communication control device of the at least one additional user station due to an error, and if the second communication control device of the at least one additional user station in the meantime attempts to transmit the second error frame.

24. A method for communicating in a serial bus system, the method comprising the following steps:
transmitting, via a transceiver device, messages onto a bus of the bus system and/or receiving, via the transceiver device, messages from the bus of the bus system;
generating, using a shield decision block, a signal that indicates, upon receipt of a message from the bus, whether or not a transmission signal that has been created by the user station due to receipt of the message is to be transmitted onto the bus; and
blocking, using a transmission signal selection block, the transmission signal which is to indicate, via an error frame on the bus, a reception error in the message that is received from the bus, as a function of the signal that is generated by the shield decision block, so that the error frame is not transmitted onto the bus.
